(19) United States
(12) Patent Application Publication
(10) Pub. No.: US 2017/0081930 A1
(43) Pub. Date: Mar. 23, 2017

(54) System and Method for Cleaning Wellbore Cuttings and Drilling Fluid

(71) Applicant: David McMillian, Russellville, AR (US)

(72) Inventor: David McMillian, Russellville, AR (US)

(21) Appl. No.: 15/280,053

(22) Filed: Sep. 29, 2016

Related U.S. Application Data
(63) Continuation-in-part of application No. 14/317,609, filed on Jun. 27, 2014.
(60) Provisional application No. 61/839,952, filed on Jun. 27, 2013.

(51) Int. Cl. E21B 21/06; C02F 1/02; C02F 1/00; C02F 1/38; B01D 21/26; B01D 21/00

(52) U.S. Cl. CPC E21B 21/065; B01D 21/267; B01D 21/009; B01D 21/0012; C02F 1/004; C02F 1/385; C02F 1/02; C02F 2103/10

(57) ABSTRACT

A system for cleaning slurry containing drilling cuttings or drilling fluids may include a slurry sump, separator, screen, liquid tank, surge hopper, and a cleaner. The cleaner may further include a rotary retort furnace which may both dry the slurry to a cake and oxidize any organic matter. The furnace may operate at a temperature of between 1200° F. and 2000° F., inclusively. The cleaning system may recycle the liquid used by returning it to the truck that brought the slurry, or, in the case of drilling fluid, collecting the liquid for use as a fuel source or reconstituting the drilling fluid by mixing the liquid with the cake after heating. The cleaned slurry produced by the system may be suitable for re-use or non-hazardous disposal.

### CROSS-REFERENCE TO RELATED APPLICATIONS

This application is a continuation-in-part of U.S. patent application Ser. No. 14/317,609, filed on Jun. 27, 2014, and entitled “System and Method for Cleaning Fracking Sand,” which in turn claims the benefit of U.S. provisional patent application No. 61/839,952, filed on Jun. 27, 2013, and entitled “System and Method for Cleaning Fracking Sand.” Such applications are incorporated herein by reference in their entirety.

### STATEMENT REGARDING FEDERALLY SPONSORED RESEARCH OR DEVELOPMENT

Not applicable.

### BACKGROUND OF THE INVENTION

Hydraulic fracturing or “fracking” is an increasingly used method to extract natural gas and oil from the earth. Hydraulic fracturing involves the introduction of a high-pressure mixture of a liquid (typically water or an oil such as diesel oil) and sand and/or chemicals into faults or cracks in rock structures, such as shale. The mixture is pumped through a wellbore deep underground and the pressure creates larger fractures. The sand opens fissures in the shale formations, allowing for the release of the gas or petroleum back up the wellbore. After achieving its purpose, the mixture is then extracted from the well as waste slurry containing liquid, sand, and some organic matter extracted from the ground. This waste slurry is subject to strict regulations, most notably by the U.S. Environmental Protection Agency, and therefore slurries containing certain contaminants can be immensely difficult and expensive to dispose of. In addition, the volatile organics in the waste slurry create a risk of fire or explosion, and thus caution must be exercised when the waste slurry is collected in “pits” after exiting back out of the top of the wellbore.

The waste slurry from a drilling and extraction process contains several components. In addition to the fracking sand, it includes the drill “cuttings” that are made up of broken bits of sold material from within the well, which are returned up the wellbore in the extraction process. Cuttings can include particles in a size range from fine silt up to pebbles and even smaller rocks. The slurry also includes drilling fluid (also known as drilling “mud”), which as noted previously may be either water-based or oil-based. Drilling mud has numerous purposes; it may be used to clean and condition a hole during drilling; to counterbalance formation pressure by providing hydrostatic pressure in the well; to prevent formation fluids from entering the well bore; to cool and clean the drill bit during drilling; and to carry out drill cuttings. The particular type of drilling fluid chosen for an application is based, in part, on the desire to avoid damage to the hydrocarbon-yielding shale formation and to limit corrosion of the drilling equipment. Many oil-based drilling fluids include diesel oil as a major constituent.

Oil-based drilling fluids are relatively volatile, and do not remain stable indefinitely. Various qualities of the oil-based drill fluids must be checked periodically in order to maintain viability and proper viscosity. For example, many oil-based drilling fluids include calcium chloride to prevent shale formations from hydrating, swelling, and sloughing into the wellbore, and maintenance of the chloride levels in these drilling fluids is thus important. If there is a slowdown in drilling operations, these drilling fluids may be stored in tanks awaiting later use. In order to maintain their viability, however, they must be regularly re-processed while stored; otherwise, these drilling fluids may be unusable when drilling operations begin again.

It may be seen therefore that it is desirable to develop an effective and environmentally friendly method of cleaning a waste slurry containing drilling cuttings and of cleaning and maintaining drilling mud. Washing and drying systems may tend to use wash water, and produce a quantity of dust. It would be advantageous to recycle at least part of the wash water, and thereby to reduce overall water consumption as compared to using only fresh water. Further, an effective method for oxidizing the organic matter contained in the slurry would be desirable for safe, environmentally sound disposal of drill cutting solids, and for safe storage and maintenance of drilling fluids.

### BRIEF SUMMARY OF THE INVENTION

According to at least one exemplary embodiment, a system for cleaning a slurry, which may be a slurry from the wellbore containing drill cuttings, or drilling fluids, may include a material sump, separator, screen, liquid tank, surge hopper, and cleaner. The cleaner may further include a rotary retort furnace which may both dry the material and oxidize any organic matter. The cleaning system may recycle the liquid used by dispensing it into a storage container, a truck that brought the material, or in any other way. Further, the dried and cleaned drill cuttings produced by the system may be suitable for non-hazardous disposal. Drilling fluids cleaned by the system may be suitable for either reuse or non-hazardous disposal. For example, drilling fluids processed according to certain embodiments of the invention may be sold or used separately (diesel oil, for example, has a value apart from its function as a constituent in certain drilling fluids, and may be sold or used as a fuel source).

These and other features, objects and advantages of the present invention will become better understood from a consideration of the following detailed description of the preferred embodiments and appended claims in conjunction with the drawings as described following:

### BRIEF DESCRIPTION OF THE SEVERAL VIEWS OF THE DRAWINGS

FIG. 1 is a diagram of an implementation of a cleaning system according to an embodiment of the invention.

FIG. 2 is a top-down view of a cleaning system according to an embodiment of the invention, showing a possible orientation of the components of the system.

FIG. 3 is a side view of a cleaning system according to an embodiment of the invention, showing a possible orientation of the components of the system.

FIG. 4 is a side view of a cleaner component according to an embodiment of the invention.

FIG. 5 is a side view of a cleaning system according to an embodiment of the invention.

FIG. 6 is a side view of a V-bottom tank according to an embodiment of the invention.

FIG. 7 is a side view of a retort furnace natural gas tumbler according to an embodiment of the invention.

FIG. 8 is a side view of a twin auger conveyor pre-heat tank hopper according to an embodiment of the invention.

FIG. 9 is a side view of a dry bulk hopper according to an embodiment of the invention.

### DETAILED DESCRIPTION OF THE PREFERRED EMBODIMENT(S)

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments,” or “invention” do not require that all embodiments of the invention include the discussed feature, advantage or mode of operation.

According to at least one exemplary embodiment, a system for cleaning a slurry, such as containing drill cuttings from the wellbore or drilling fluid (mud), may include a material sump, separator, screen, liquid tank, surge hopper, and a cleaner. The cleaner may further include a rotary retort furnace which may both dry the material and oxidize any organic matter. The cleaning system may recycle the liquid used by dispensing it into a storage container, a truck, or in any other way. Further, the cleaned material produced by the system may be suitable for re-use or non-hazardous disposal. Separated drill fluid may be reconstituted for re-use.

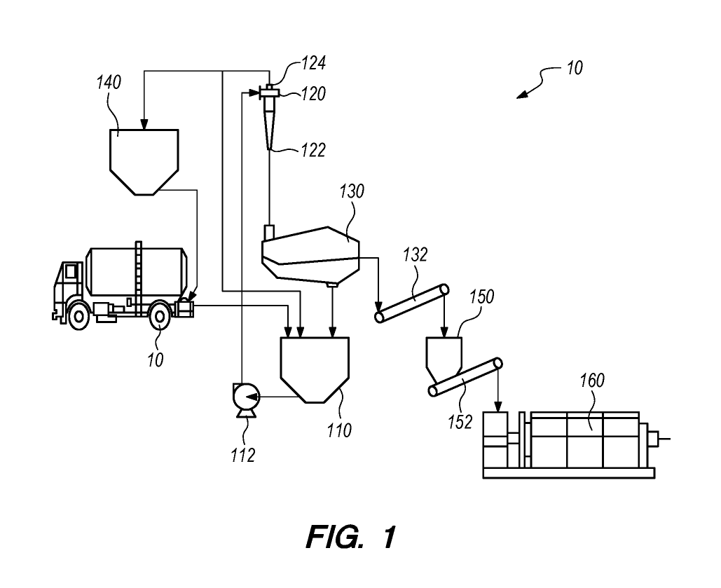

Exemplary FIG. 1 shows a schematic diagram of an embodiment of cleaning system 100. Cleaning system 100 may include a slurry sump 110, a separator 120, a screen 130, a liquid tank 140, a surge hopper 150, and a cleaner 160. The material to be cleaned may be provided by means of a truck 10. Alternatively, the material may be provided by another vehicle, such as a train, or may be provided directly from the well in the case of a slurry containing drilling cuttings, from a storage tank as in the case of drilling fluids, or as desired.

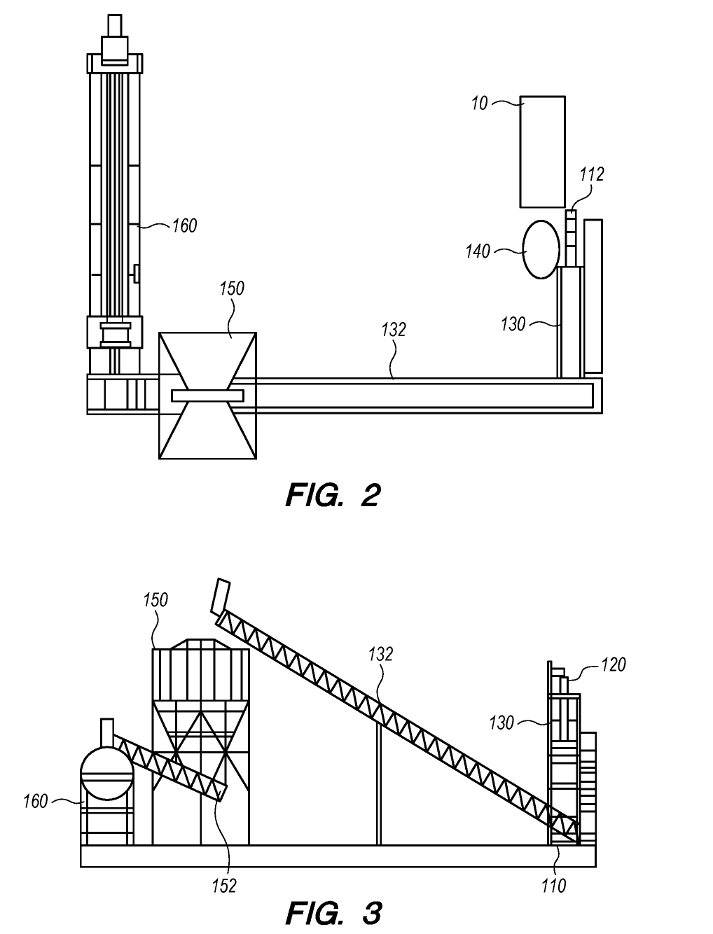

Referring generally to exemplary FIGS. 1, 2, and 3, slurry may be transported to be cleaned in a truck 10. According to some embodiments, truck 10 may be a vacuum truck. Alternative delivery mechanisms such as from another type of vehicle or directly from the well are also envisioned; however, here only a truck will be referred to for clarity. The material may be pumped from truck 10 into slurry sump 110 by way of hoses or by any other means, as desired. The rate of material pumping from truck 10 to slurry sump 110 may vary depending on the capacity of the cleaning system. In an exemplary embodiment, the rate of material pumping from truck 10 to slurry sump 110 may be any rate up to 300 gallons per minute. Slurry sump 110 may temporarily store material to achieve a desired throughput for the rest of cleaning system 100, if desired. Material may then be pumped out of slurry sump 110 by means of slurry pump 112. Slurry pump 112 may pump material to separator 120.

Separator 120 may have the ability to functionally separate the waste slurry in a lighter portion of excess liquid without particulate matter in it and a denser portion containing partially solidified waste slurry, such as the solids in the drilling cuttings slurry from the wellbore or the solids from drilling mud. Separator 120 may be, for example, a hydrocyclone, a centrifuge, or as desired. Separator 120 may have two exits: an underflow 122 and an overflow 124. The partially solidified slurry may exit separator 120 at underflow 122 and travel to screen 130. The excess liquid may exit separator 120 at overflow 124 and travel to either slurry sump 110 or liquid tank 140.

Screen 130 may vibrate and further remove liquids from the material. Excess liquid extracted by screen 130 may flow back to slurry sump 110.

Excess liquid from separator 120 may flow either back to slurry sump 110 or to liquid tank 140, as desired. A valve may be used to determine the direction of the liquid flow to maintain a desired liquid level in slurry sump 110. Liquid in liquid tank 140 may be pumped back onto truck 10 for reconstitution or for disposal, as desired. Alternatively, liquid in liquid tank 140 may be recycled or disposed of onsite. In the case of liquids that may be used as fuel, such as diesel oil, the oil may be sold separately or used onsite as a fuel source.

Cake exiting screen 130 may be transported to surge hopper 150. Cake may be transported by conveyer belt 132, or as desired. Surge hopper 150 may allow cake to flow along feeder 152 into cleaner 160 at a desired rate. Surge hopper 150 may also serve as a temporary storage for cake, if desired.

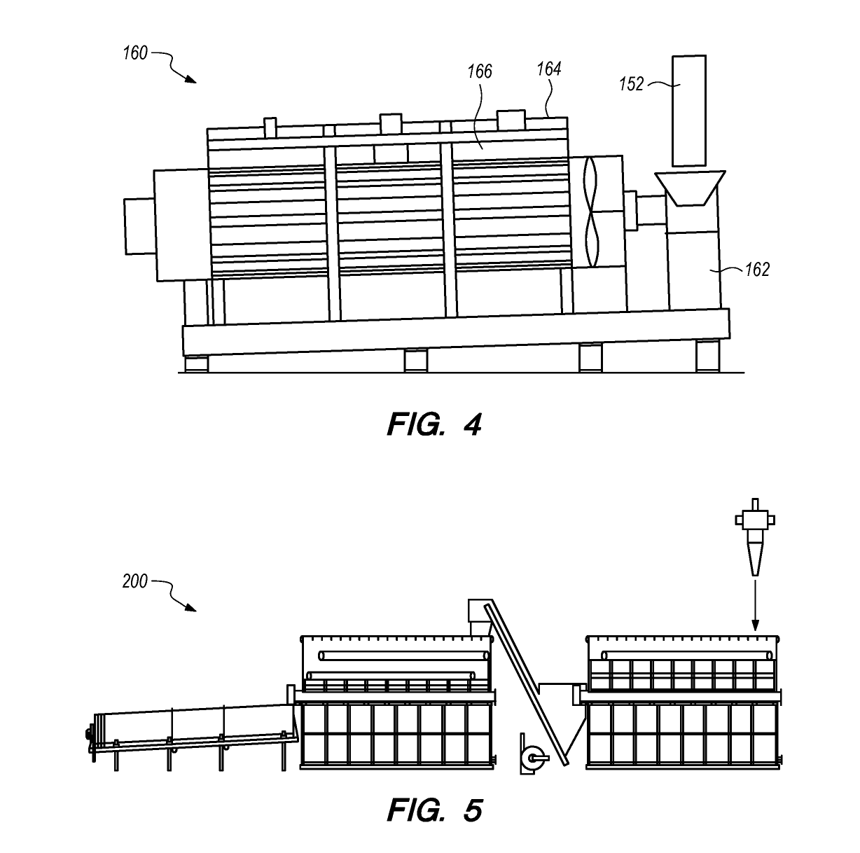

Referring now to exemplary FIG. 4, cake from feeder 152 may enter cleaner 160 through screw feeder 162. Screw feeder 162 may ensure a constant flow of cake into cleaner 160. From screw feeder 162, cake may enter rotary retort furnace 164. Furnace 164 may heat cake to a high temperature, for example, between about 1,200° F. and about 2,000° F. inclusively, which may completely dry cake and oxidize organic materials. Further, furnace 164 may rotate, causing material to be mixed and cascaded for even processing. Furnace 164 may have an annular cavity 166 between its outside and inside surfaces. Burners may be fired into the annular cavity 166, providing for indirect heating of the cake.

Cleaner 160 may further include an air valve. The air valve may be coupled directly to screw feeder 162 or to furnace 164. The air valve may allow for the control of airflow in furnace 164; this airflow may in turn control both the drying of the cake and the oxidization of organic matter in the cake material. In one embodiment, airflow may be adjusted to provide for an oxygen concentration between 5% and 10%, inclusively, within furnace 164 at initial startup. The air valve may be either manual or automatically adjustable, as desired.

After passing through cleaner 160, the processed material may be dry and free of any organic content. Processed material may be suitable for re-use, for example in a fracking operation or other uses, or non-hazardous disposal.

Smaller-scale and larger-scale embodiments of the invention are both envisioned. According to some embodiments, an embodiment of the disclosed cleaning system may be able to process 1,500 barrels of slurry per day. In addition, according to one exemplary embodiment, the slurry may contain up to about 30% solid matter before processing.

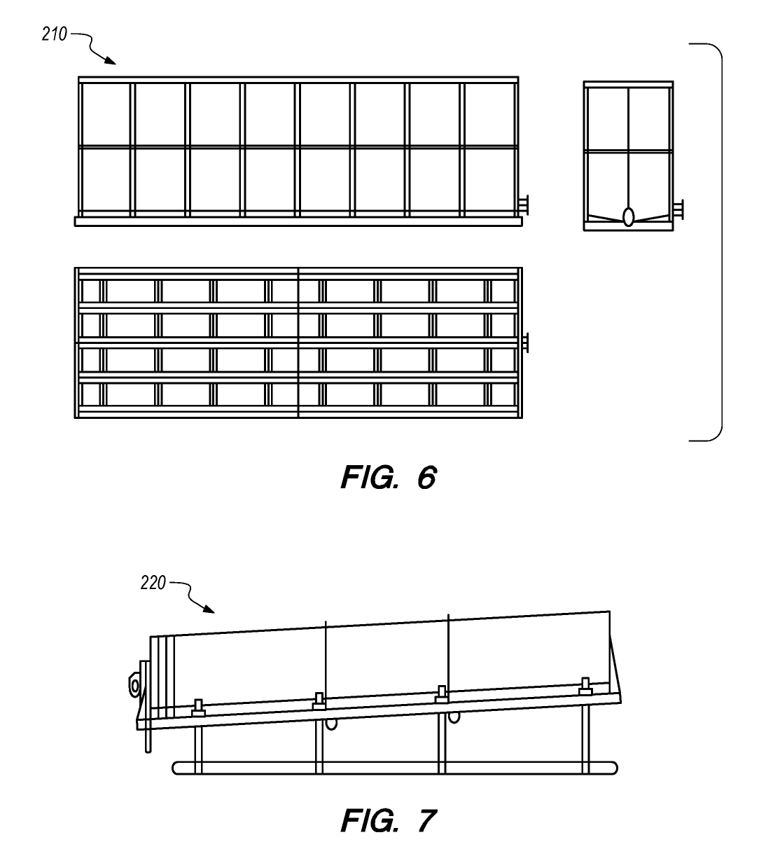

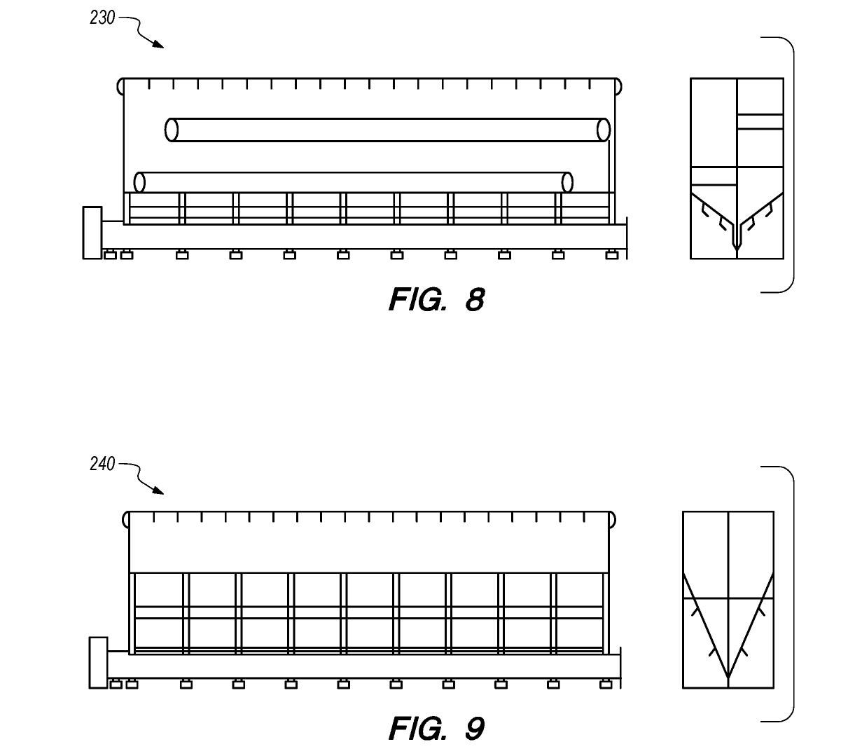

As shown in exemplary FIG. 5-9, some embodiments may include a V-bottom slurry tank 210, a dry bulk hopper 240, a twin auger conveyor pre-heat hopper 230, and a retort furnace natural gas tumbler 220. Retort furnace natural gas tumbler 220 may be configured such that cake is fed into the tumbler by a belt or auger. In an exemplary embodiment, cake may be transferred to the tumbler from twin auger conveyor pre-heat hopper 230. The tumbler may be substantially tubular and may be sloped such that gravity causes the material to travel through the tumbler and fall out the end opposite the feeder. Cake may be deposited onto the interior surface of the tumbler tube. The tumbler may rotate, causing the material to mix and spread as it slides down the rotating tube. A barrier may be disposed within the tumbler tube. The barrier may substantially form an inner tube within the tumbler tube. The barrier may or may not be continuous. The barrier may be made of substantially heat resistant, heat reflective, or heat dispersing material. The material may travel along the interior of the tumbler tube outside of the barrier. A heating element may be disposed within the barrier tube, such that the barrier is between the heating element and the material. The barrier may increase or decrease the heat exposure of the material and may disperse the heat evenly. In at least one exemplary embodiment, the heating element may be a burner configured to project heat into the tumbler tube. The burner may be disposed at the end of the tube opposite the feeder. As the material travels down the tumbler tube, it may be evenly heated and cleaned. Heat may be radiated from the burner, the barrier, and the tumbler tube itself, causing for uniform heating and cleaning. The dry, cleaned material may fall out of the tumbler tube and be collected for disposal or reuse. In certain cases when drilling mud is the slurry, the cake may be returned for reconstitution with the liquid components after cleaning. Alternatively, the cake may be simply disposed of because of its non-hazardous nature after cleaning, and the liquid components can be reused or, in the case of liquids that serve as fuel such as diesel oil, may be sold as fuel or used as a fuel source onsite.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. When a grouping is used herein, all individual members of the group and all combinations and subcombinations possible of the group are intended to be individually included. When a range is stated herein, the range is intended to include all subranges and individual points within the range. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A system for cleaning a slurry, the slurry comprising at least a solid material and a liquid, comprising:
a separator;
a screen; and
a cleaner;
wherein the separator is configured to separate the slurry into a first portion and a second portion, the first portion comprising excess liquid substantially free of particulate matter, and the second portion comprising partially concentrated material, wherein the screen is configured to remove the liquid from said second portion until it contains at least about 85% solid matter and less than about 2% combustible organic matter, and wherein the cleaner includes a furnace, said furnace configured to heat said second portion to a temperature sufficient to remove substantially all liquid and oxidize substantially all organic matter contained in said second portion.

2. The system of claim 1, further comprising:
a slurry sump; and
a slurry pump, the slurry pump configured to pump material out of the slurry sump.

3. The system of claim 2, further comprising a liquid tank, wherein the slurry sump, liquid tank, and separator are in fluid communication with each other, wherein the slurry sump may be configured to receive the material from an outside source and the separator may be configured to receive the material from the slurry sump, and wherein both the liquid tank and the slurry sump are configured to receive the first portion from the separator.

4. The system of claim 1, further comprising a surge hopper.

5. The system of claim 1, wherein the separator is a hydrocyclone.

6. The system of claim 1, wherein the furnace is configured to heat said second portion to a temperature between 1200° F. and 2000° F., inclusively.

7. The system of claim 1, wherein the furnace is a rotary retort furnace.

8. The system of claim 1, wherein the furnace is configured to control the oxygen content of the gases inside the furnace.

9. The system of claim 8, wherein the furnace is configured to maintain the oxygen content of the gases inside the furnace to between 5% and 10%, inclusively.

10. The system of claim 1, wherein the slurry comprises drilling cuttings from a wellbore.

11. The system of claim 1, wherein the slurry comprises drilling fluid.

12. A method for cleaning a slurry, the slurry comprising at least a solid and a liquid, comprising:
receiving the slurry from an outside source;
separating the slurry in a separator into a first portion and a second portion, wherein the first portion comprising excess liquid substantially free of particulate matter, and the second portion comprising partially concentrated slurry;
removing the liquid from said second portion until it becomes a cake, said cake containing at least about 85% solid matter and less than about 2% combustible organic matter; and
heating the cake in a furnace to a temperature sufficient to remove substantially all liquid and oxidize substantially all organic matter contained in said cake.

13. The method of claim 12, wherein the cake is heated to a temperature between 1200° F. and 2000° F., inclusively.

14. The method of claim 12, further comprising controlling the oxygen content of the gases inside the furnace.

15. The method of claim 12, wherein the oxygen content of the gases inside the furnace is maintained to between 5% and 10%, inclusively.

16. The method of claim 12, further comprising controlling the rate of flow of the cake into the furnace.

17. The method of claim 12, wherein the slurry comprises drilling cuttings.

18. The method of claim 12, wherein the slurry comprises drilling fluid.

19. The method of claim 18, wherein the drilling fluid comprises a liquid that is a fuel source and comprising collecting the liquid for subsequent combustion.

20. The method of claim 18, further comprising reconstituting the drilling fluid by mixing the liquid and cake after heating the cake.
